(19) United States
(12) Patent Application Publication
(10) Pub. No.: US 2014/0335266 A1
(43) Pub. Date: Nov. 13, 2014

(54) Process For Preparing A Sol-Gel From At Least Three Metal Salts And Use Of The Process For Preparing A Ceramic Membrane

(71) Applicants: L'Air Liquide, Societe Anonyme Pour I'Etude et I'Exploitation des Procedes Georges Claude, Paris (FR); Centre National De La Recherche Scientifique, Paris (FR); Universite de Limoges, Limoges (FR)

(72) Inventors: Nicolas Richet, Fontenay-Le-Fleury (FR); Thierry Chartier, Feytiat (FR); Fabrice Rossignol, Verneuil Sur Vienne (FR); Aurelien Vivet, Alby-Sur-Cheran (FR); Pierre-Marie Geffroy, Limoges (FR)

(21) Appl. No.: 14/364,389

(22) PCT Filed: Sep. 26, 2012
(86) PCT No.: PCT/EP2012/068923

§ 371 Date: Jun. 11, 2014

(30) Foreign Application Priority Data
Dec. 15, 2011 (FR) 1161690

(51) Int. Cl. C04B 35/624; C04B 35/50; C04B 41/87; B05D 1/18

(52) U.S. Cl. CPC C04B 35/624; B05D 1/18; C04B 35/50; C04B 41/87
USPC 427/126.1; 427/346; 106/287.18; 501/152

(57) ABSTRACT

Method for preparing a sol-gel corresponding to the general formula (I):

A₍₁₋ₓ₎A′ₓB_{(1-y-u)}B′_{y}B″ᵤO_{3-δ}, (I),
said method comprising the following steps:
a) Preparing an aqueous solution of water-soluble salts of said elements A, A′, optionally A″, B, and B′, in stoichiometric proportions needed to obtain the material as defined above; b) preparing a hydro-alcoholic solution of at least one non-ionic surfactant in an alcohol, mixed with an aqueous solution of ammonia in a proportion sufficient to ensure the complete dissolution of said non-ionic surfactant in said hydroalcoholic solution, the concentration of said non-ionic surfactant in said hydro-alcoholic solution being less than the critical micelle concentration; c) mixing said aqueous solution prepared in step a), with said alcoholic dispersion prepared in step b) to form a sol; d) drying said sol obtained in step c), by evaporating the solvent, to obtain a sol-gel.

### CROSS REFERENCE TO RELATED APPLICATIONS

This application is a §371 of International PCT Application PCT/EP2012/068923, filed Sep. 26, 2012, which claims the benefit of FR1161690, filed Dec. 15, 2011, both of which are herein incorporated by reference in their entireties.

### TECHNICAL FIELD OF THE INVENTION

The present invention concerns catalytic membrane reactors, or CMRs. Its main purpose is to improve the oxygen semi-permeation of ceramic membranes implemented in catalytic membrane reactors.

### BACKGROUND

A catalytic membrane reactor is composed of a mixed conductive dense membrane (electronic and ionic) of oxygen anions. Under the action of an oxygen partial pressure gradient imposed on both sides of the membrane, O²⁻ oxygen anions, coming from the air, passing through the membrane of the oxidizing surface to the reducing surface, in order to react with methane on the latter. FIG. 1 depicts all of the elementary steps in the transportation of oxygen through a membrane, which are six in number:
The absorption of oxygen onto the oxidizing surface of the membrane;
The dissociation of oxygen and recombination into O²⁻ anions;
The diffusion of oxygen through the membrane's volume;
The recombination of oxygen;
The desorption of oxygen of the membrane's reducing surface;
The reaction of pure oxygen with methane

However, each of the steps previously described can be a limiting step in the transportation of oxygen through the membrane.

It has been determined that for perovskite membranes, the limiting step and the surface exchanges, and more particularly the reducing surface of the membrane [P. M. Geffroy et al., “Oxygen semi-permeation, oxygen diffusion and surface exchange coefficient of La₍₁₋ₓ₎SrₓFe_{(1-y)}Ga_{y}O_{3-d} perovskite membranes”, Journal of Membrane Science, (2010) 354(1-2) p. 6-13; P. M. Geffroy et al., “Influence of oxygen surface exchanges on oxygen semi-permeation through La₍₁₋ₓ₎SrₓFe_{(1-y)}O_{3-δ}dense membrane” Journal of Electrochemical Society, (2011), 158 (8), p. B971-B979;] To increase these exchanges, it is therefore necessary to modify the exchange surfaces between the gases. The two possible options are either to increase the exchange surface by developing the porosity of the membrane's surface and then increase the number of active sites where the exchanges preferentially take place, or to increase the density of grain boundaries. To do so, an architecture must be created that has a porous surface (the exchange surface area relative to the form factor is maximized) with the smallest possible grains.

The surface condition of the membranes for the CMR application plays a crucial role in the performance of the method [P. M. Geffroy et al., “Oxygen semi-permeation, oxygen diffusion and surface exchange coefficient of La₍₁₋ₓ₎SrₓFe_{(1-y)}Ga_{y}O_{3-d} perovskite membranes”, Journal of Membrane Science, (2010) 354(1-2) p. 6-13; P. M. Geffroy et al., “Influence of oxygen surface exchanges on oxygen semi-permeation through La₍₁₋ₓ₎SrₓFe_{(1-y)}Ga_{y}O_{3-δ}dense membrane” Journal of Electrochemical Society, (2011), 158 (8), p. B971-B979; H. J. M. Bouwmeester et al., “Importance of the surface exchange kinetics as rate limiting step in oxygen permeation through mixed-conducting oxides”, Solid State Ionics, (1994) 72(PART 2) p. 185-194; S. Kim et al., “Oxygen surface exchange in mixed ionic electronic conductor membranes.” Solid State Ionics, (1999) 121(1) p. 31-36].

To optimize the conversion rate of methane, either the accessibility of the reagents to the active particles must be improved, or the exchange surface area between the oxygen and the methane particles must be increased.

However, the two primary barriers to the development of supports with large specific surface area are sintering, a natural phenomenon appearing at high temperature, and the thickness of the porous layer.

During sintering to eliminate the blowing agents introduced into screen-printing inks or during co-sintering, the cohesiveness of the layer as a whole is obtained by modifying the powder grains, which is more particularly reflected in their expansion. There is therefore a decrease in the density of grain boundaries. However, the current material synthesis methods do not make it possible to obtain grains with a very small diameter. Additionally, if the thickness of the layer is too high, the tortuosity in the porosity increases; this therefore reduces the useful surface area on which the surface exchanges can take place.

### SUMMARY OF THE INVENTION

One of the objects of the present invention is therefore to propose an operating protocol that makes it possible to obtain a nanostructured architecture which, at a high temperature, meaning a temperature greater than the crystallization temperature, is an ultra-thin perovskite composed of crystallites 10-100 nm in diameter. The material layer formed in this way develops a large specific surface area and has a high density of grain boundaries. It also has an increased microstructural stability, both in terms of grain size and density of grain boundaries, at a high temperature (700° C. at 1000° C.) and for a long period of time (more than 2000 hours).

The methods generally in use today, to increase the exchange surface area of the membranes, are depositing a porous layer by screen printing, to use a porous medium in which the porosity is created by the use of a blowing agent, and using mesoporous materials.

Screen printing consists of first preparing a so-called “screen-printing” ink, formed of powdered material, of a blowing agent like cornstarch, rice starch, or potato starch, and a medium Lee et al., “Oxygen-permeating property of LaSrBFeO_{3-d} (B=Co, Ga) perovskite membrane surface-modified by LaSrCoO₃”, Solid State Ionics, (2003) 158(3-4) p. 287-296]. Screen-printing ink is then deposited onto the membrane using a blade that forces ink through the screen-printing mask in order to print the desired patterns. The deposited thickness is between 20 μm and 100 μm. FIG. 2 is a photo taken by a scanning electron microscope (SEM photo) of a porous surface deposited by screen-printing onto a medium. The porous media are produced by co-sintering a dense membrane associated with a membrane comprising blowing agents (A. Julian et al., “Elaboration of La_{0.8}Sr_{0.2}Fe_{0.7}Ga_{0.3}O_{3-d}/La_{0.8}M_{0.2}FeO_{3-d} (M=Car, Sr and Ba) asymmetric membranes by tape-casting and co-firing”; Journal of Membrane Science, (2009) 333(1-2) p. 132-140; G. Etchegoyen et al., “An architectural approach to the oxygen permeability of a La_{0.6}Sr_{0.4}Fe_{0.9}Ga_{0.1}O_{3-d} perovskite membrane.” Journal of the European Ceramic Society, (2006) 26(13) p. 2807-2815″]. The blowing agents are removed during thermal treatment in order to leave behind the residual porosity. This method has been widely described in the literature but is mainly for providing a mechanical support for the membranes rather than a larger exchange surface area. FIGS. 3A and 3B are photos taken by a scanning electron microscope (SEM photo) of porous bilayer substrates with a dense membrane.

The production of mesoporous substrates has been developed over the past decade or so for various applications. However, these methods have not made it possible to obtain an ultrathin substrate that is stabilized during the crystallization of the perovskite phase.

The object of the present invention is therefore a method for preparing a perovskite phase sol with controlled stoichiometry, having at least four cations and stable over time. After dip-coating, during the crystallization of that sol at its temperature, a layer with an ultrathin or nanostructured architecture formed of perovskite phase particles 10-100 nm in diameter is deposited onto the surface of the membrane. One essential characteristic of the invention relates to the very high increase in grain boundaries on the surface of the membrane, as well as the considerable increase of the exchange surface and the oxygen flow traversing the membrane.

According to a first aspect, the object of the invention is therefore a method for preparing a sol-gel of at least three metal salts M₁, M₂, and M₃ suitable and intended for preparing a perovskite material corresponding to the general formula (I):

A₍₁₋ₓ₎A′ₓB_{(1-y-u )}B′_{y}B″ᵤO_{3-δ}, (I),

a formula (I) wherein

x, y, u and δ are such that the electrical neutrality of the crystal lattice is preserved,

0≦x≦0.9,

0≦u≦0.5,

(y+u)≦0.5,

0≦y≦0.5 and 0<δ

and a formula (I) wherein:

A represents an atom chosen from among scandium, yttrium, or from the lanthanide, actinide, or alkaline earth metal families;

A′, which is different from A, represents an atom chosen from among scandium, yttrium, aluminum, gallium, indium, thallium, or from the lanthanide, actinide, or alkaline earth metal families;

B represents an atom chosen from among the transitional metals;

B′, which is different from B, represents an atom chosen from among the transitional metals, the metals in the alkaline earth metal family, aluminum, indium, gallium, germanium, antimony, bismuth, tin, or lead;

B″, which is different from B and from B′, represents an atom chosen from among the transitional metals, the metals in the alkaline earth metal family, aluminum, indium, gallium, germanium, antimony, bismuth, tin, lead, or zirconium;

said method comprising the following steps:

A step a) of preparing an aqueous solution of water-soluble salts of said elements A, A′, B, B′ and optionally B″, in stoichiometric proportions needed to obtain the material as defined above;

A step b) of preparing a hydro-alcoholic solution of at least one non-ionic surfactant in an alcohol chosen from among methanol, ethanol, propanol, isopropanol, or butanol, mixed with an aqueous solution of ammonia in a proportion sufficient to ensure the complete dissolution of said non-ionic surfactant in said hydroalcoholic solution, the concentration of said non-ionic surfactant in said hydro-alcoholic solution being less than the critical micelle concentration;

A step c) of mixing said aqueous solution prepared in step a), with said alcoholic dispersion prepared in step b) to form a sol;

A step d) of drying said sol obtained in step c), by evaporating the solvent, to obtain a sol-gel.

The term “sol-gel of at least three metals M₁, M₂, and M₃ suitable and intended for preparing a perovskite material” particularly refers to a sol of three metals, a sol-gel of four metals, or a sol-gel of five metals.

For the implementation of step a) of the method as defined above, the anions of the water-soluble salts of said elements A, A′, B, B′ and optionally B″, are of a lower valence than that of the corresponding cation.

Thus, for an element A, A′, B, B′ or B″ of valence +2, the negative counterion is an anion of valence −1; in this option, this anion is more particularly chosen from halide ions or the nitrate ion, and preferably, is the nitrate ion.

For an element A, A′, B, B′ or B″ of valence +3, the negative counterion is an anion of valence −1 or valence −2; in this option, this anion is more particularly chosen from halide ions, the nitrate ion, or the sulfate ion; preferably, it is the nitrate ion.

For an element A, A′, B, B′ or B″ of valence +4, the negative counterion is an anion of valence −1, valence −2 or valence −3; in this option, this anion is more particularly chosen from halide ions, the nitrate ion, the sulfate ion, or the phosphate ion; preferably, it is the nitrate ion.

According to one particular aspect of the method as defined above, the water-soluble salts of said elements A, A′, B, B′ and optionally B″, implemented in step a), are the nitrates of said elements.

According to another particular aspect of the method as defined above, in the aqueous solution prepared in step a), the molar ratio:
Number of moles of the water-soluble salts of said elements A, A′, B, B′ and optionally B″ (Nₛₐₗₜₛ/Number of water moles (N_{H2O}),
   is particularly greater than or equal to 0.005 and less than or equal to 0.05.

In the context of step b) of the method as defined above, the term “hydroalcoholic solution” means that the alcohol-water mixture contains at least 70% alcohol by weight and at most 30% water by weight.

According to one particular aspect of the method as defined above, the alcohol implemented in step b) is ethanol.

The term “a proportion sufficient to ensure the complete dissolution of said non-ionic surfactant in said hydroalcoholic solution ” in step b) of the method as defined above means that the molar ratio N_{(surfactant)}/N_{(NH3)} is greater than 10⁻⁴ and less than or equal to 10⁻²

According to another particular aspect of the method as defined above, the non-ionic surfactant implemented in step b) is chosen from among block copolymers formed of poly(alkyleneoxy) chains, and more particularly the copolymers (EO)ₙ-(PO)ₘ-(EO)ₙ.

According to another particular aspect of the method as defined above, the non-ionic surfactant implemented in step b) is a (EO)₉₉-(PO)₇₀-(EO)₉₉ block copolymer sold under the name PLURONIC™F127

In the formula (I) as defined above, A and A′ are more particularly chosen from lanthanum (La), cerium (Ce), yttrium (Y), gadolinium (Gd), magnesium (Mg), calcium (Ca), strontium (Sr), and barium (Ba).

According to one very particular aspect of the invention, in the formula (I), A represents a lanthanum atom, a calcium atom, or a barium atom.

According to another very particular aspect of the invention, in the formula (I), A′ represents a strontium atom.

In the formula (I) as defined above, B and B′ are more particularly chosen from among iron (Fe), chromium (Cr), manganese (Mn), gallium (Ga), cobalt (Co), nickel (Ni), and titanium (Ti).

According to another very particular aspect of the invention, in the formula (I), B represents an iron atom.

According to another very particular aspect of the invention, in the formula (I), B′ represents a gallium atom, a titanium atom, or a cobalt atom.

According to another very particular aspect of the invention, in the formula (I), B″ represents a zirconium atom.

In the formula (I) as defined previously, u is more particularly equal to 0.

According to a more particular aspect of the invention, one object of the invention is a method as previously defined, for which the perovskite material of formula (I) is chosen from among the following compounds:

La₍₁₋ₓ₎ Srₓ Fe(_{1-y)} Co_{y} La_{(1-x) Sr}ₓ Fe_{(1-y)} Ga_{y} O₃₋₆₇ , La₍₁₋ₓ₎ Srₓ Fe_{(1-y)} Ti_{y} O_{3-δ}, Ba₍₁₋ₓ₎ Srₓ Fe_{(1-y)} Co_{y} O_{3-δ}, Ca Fe_{(1-y)} Ti_{y} O_{3-δ}, and La₍₁₋ₓ₎SrₓFeO_{3-δ}

and more particularly from among the following compounds:

La_{0.6} Sr_{0.4} Fe_{0.9} Ga_{0.1} O_{3-δ}, La_{0.5} Sr_{0.5} Fe_{0.9} Ti_{0.1} O_{3-δ},

La_{0.6} Sr_{0.4} Fe_{0.9} Ga_{0.1} O_{3-δ}, La_{0.5} Sr_{0.5} Fe_{0.9} Ti_{0.1} O_{3-δ}, La_{0.5} Sr_{0.5} Fe_{0.9} Ti_{0.1} O_{3-δ}, La_{0.6} Sr_{0.4} Fe_{0.9} Ga_{0.1} O_{3-δ}, et La_{0.8} Sr_{0.2} Fe_{0.7}Ga_{0.3} O_{3-δ}.

A further object of the invention is a method for preparing a substrate coated on at least one of its sides with a sol-gel film of a perovskite material, characterized in that it comprises:

A step e) of dipping a substrate formed of a sintered perovskite material whose density is above 90%, and preferably 95%, in the sol derived from step c) of the method as previously defined, to obtain a dipped substrate;

A step f) of drawing said dipped substrate derived from step e) at constant speed, in order to obtain a substrate coated with a film of said sol;

A step g) of drying said substrate coated with a film of said sol obtained in step f), by evaporating the solvent, to obtain said substrate coated with a sol-gel.

In the method as defined above, step e) of dipping consists of immersing a substrate into the sol previously synthesized and of removing it at a controlled, constant speed.

In the method as defined above, during step f) of drawing, the motion of the substrate drags the liquid, forming a surface coat. This coat is divided in two; the inner part moves with the substrate while the outer part drops back into the container. The gradual evaporation of the solvent leads to the formation of a film on the surface of the substrate.

It is possible to estimate the thickness of the deposit obtained as a function of the viscosity of the sol and the drawing speed.

e=ακv^{2/3}

e being the thickness of the deposit, κ being a deposit constant that depends on the viscosity and density of the sol and the liquid-vapor surface tension, and v being the drawing speed. This way, the higher the drawing speed, the thicker the deposit will be.

In the method as defined above, step g) of drying is generally performed in the open air or in a controlled atmosphere for several hours.

The term “sintered perovskite material whose density is above 90%, and preferably 95%” more particularly refers to a ceramic composition (CC) comprising, out of 100% of its volume, at least 75% by volume and up to 100% by volume of a mixed electronic conductive compound and of oxygen anions O²⁻ (C₁) chosen from among doped ceramic oxides of formula (II):

C₍₁₋ₓ₋ᵤ₎C′ₓD_{(1-y-u)}D′_{y}D″ᵤO_{3-δ}, (II),

a formula (II) wherein:

x, y, u and δ are such that the electrical neutrality of the crystal lattice is preserved,

0≦x≦0.9,

0≦u≦0.5,

(y+u)≦0.5,

0≦y≦0.5 et 0<δ

and a formula (I) wherein:

C represents an atom chosen from among scandium, yttrium, or from the lanthanide, actinide, or alkaline earth metal families;

C′, which is different from C, represents an atom chosen from among scandium, yttrium, aluminum, gallium, indium, thallium, or from the lanthanide, actinide, or alkaline earth metal families;

D represents an atom chosen from among the transitional metals;

D′, which is different from D, represents an atom chosen from among the transitional metals, the metals in the alkaline earth metal family, aluminum, indium, gallium, germanium, antimony, bismuth, tin, or lead;

D″, which is different from D and from D′, represents an atom chosen from among the transitional metals, the metals in the alkaline earth metal family, aluminum, indium, gallium, germanium, antimony, bismuth, tin, lead, or zirconium;

and optionally up to 25% by volume of a compound (C₂), different from the compound (C₁) chosen from among magnesium oxide, calcium oxide, aluminum oxide, zirconium oxide, titanium oxide, mixed oxides of strontium and aluminum, or of barium and titanium, or of calcium and titanium; said ceramic composition (CC) having undergone a step of sintering before it is implemented in step e).

According to one particular aspect of the present invention, said ceramic composition (CC) comprises 100% by volume, at least 90% by volume, and more particularly at least 95% by volume and up to 100% by volume of compound (CO and optionally up to 10% by volume, and more particularly up to 5% by volume of compound (C₂).

According to one particular aspect of the method as defined above, the sintering undergone by the material of formula (II) before its implementation in step e), is performed in air at a temperature above 1000° C., or even above 1200° C. for about 10 hours so as to achieve the desired relative density.

According to another particular aspect of the present invention, formulas (I) and (II) as previously defined are identical.

According to another aspect, one object of the invention is a method for preparing a ceramic membrane (CM) characterized in that said substrate coated with a sol-gel obtained by the method as previously defined, undergoes a step h) of calcination in air.

In the method as defined above, step h) of calcination is generally performed in air at a temperature of 1000° C. for at least one hour, the speed at which the temperature rises being around 1° C. per minute. The calcination of substrates in air thereby makes it possible to eliminate nitrates, but also to break down the surfactant and thereby provide porosity.

According to another aspect, one object of the invention is a method for preparing an ultrathin powder of perovskite material corresponding to the general formula (I), characterized in that the sol derived from step c) of the method as previously defined undergoes a step i) of spraying in order to form a sol-gel powder; said sol-gel powder being then subjected to step h) of calcination in air, to form said ultrathin or nanostructured powder (meaning a nanoscale grain size from 10 to 100 nm).

Finally, an object of the invention is the use of the membrane as previously defined to produce oxygen from air, by electrochemistry through

[symbol]

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 depicts all of the elementary steps in the transportation of oxygen through a membrane.

FIG. 2 provides a photo taken by a scanning electron microscope (SEM photo) of a porous surface deposited by screen-printing onto a medium

FIGS. 3A-B provide photos taken by a scanning electron microscope (SEM photo) of porous bilayer substrates with a dense membrane

FIG. 4 illustrates the principle of self-assembly after the dip-coating of a substrate in the sol

FIG. 5 represents an apparatus in accordance with an embodiment of the invention.

FIG. 6 is a diffractogram of the sol-gel powder calcinated at 1000° C.

FIGS. 7A-C provide an image from an SEM/FEG microscope.

FIGS. 8A-C provide an image from an SEM/FEG microscope.

FIG. 9 shows the oxygen semi-permeation curves in an air/argon gradient as a function of temperature.

FIGS. 10A-C provide an image from an SEM/FEG microscope.

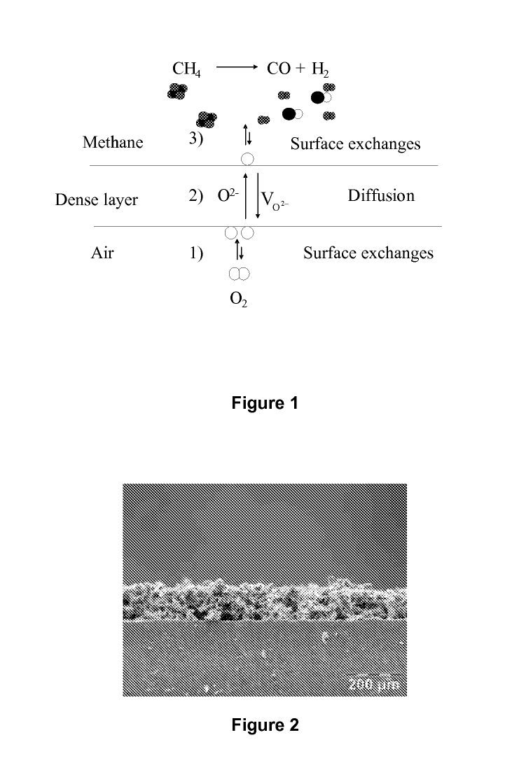

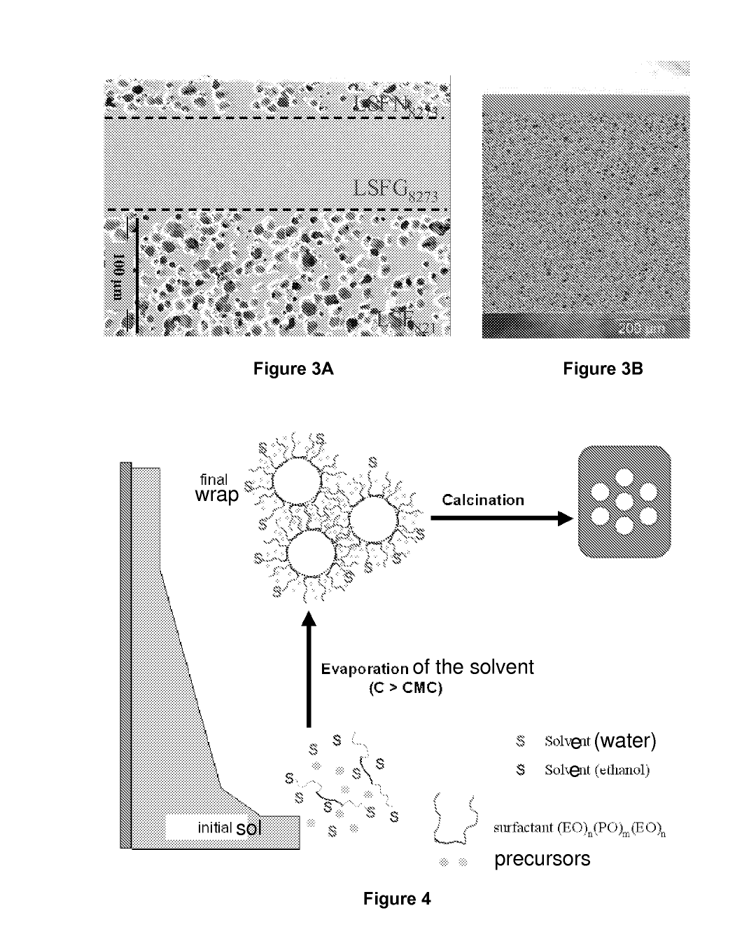

### DETAILED DESCRIPTION

The following description of experiments illustrates the invention without limiting it.

Lanthanum, strontium, iron, and gallium nitrates, which are precursors of perovskite, are mixed in stoichiometric proportions needed to form a perovskite of structure La_{0.8} Sr_{0.2} Fe_{0.7}Ga_{0.3} O_{3-δ} with a non-ionic surfactant, in an ammonia/ethanol solution. The evaporation of the solvents (ethanol and water) allows the sol to wrap around surfactant micelles through the formation of bonds between hydroxyl groups of one salt and the metal of another salt. The controlling of the hydrolysis/condensation reactions caused by the electrostatic interactions between the inorganic precursors and the surfactant molecules allows a cooperative assembly of the organic and inorganic phases, which generates micelle aggregates of surfactants of controlled size within an inorganic matrix. The phenomenon of self-assembly is caused by the gradual evaporation of a solvent of a reagent solution, once the micelle concentration has become critical.

This leads either to the formation of controlled-microstructure films in the event that the substrate is being dip-coated, or the formation of a controlled-microstructure powder after the sol is spray-dried.

The starting point of the self-arrangement process is the hydro-alcoholic solution of the inorganic precursors (La, Sr, Fe, and Ga) and the non-ionic surfactant.

The non-ionic surfactant implemented in the method belongs to the family of block copolymers, which are copolymers that have two parts with different polarities: A hydrophobic body and hydrophilic ends. These copolymers are formed of poly(alkylene oxide) chains, as copolymers of general formula (EO)ₙ-(PO)ₘ-(EO)ₙ, formed by stringing together poly(ethylene oxide) (EO), which is hydrophilic at the ends, and in its central part, polypropylene oxide) (PO), which is hydrophobic. The chains of polymers remain dispersed in the solution if their concentration is below the critical micelle concentration (CMC).

The CMC is defined as being the limit concentration above which the phenomenon of surfactant molecules arranging themselves in the solution occurs. Above that concentration, the surfactant chains tend to regroup by hydrophilic/hydrophobic affinity. When that happens, the hydrophobic bodies regroup and form spherical micelles. The ends of the polymer chains are pushed to the outside of the micelles, and join during the evaporation of the volatile solvent (ethanol) with the ionic species in the solution, which also have hydrophilic affinities.

The size of the micelles is set by the length of the hydrophobic chain. Thus, using a (EO)₉₉-(PO)₇₀-(EO)₉₉ block copolymer commercially available as Pluronic™F127, micelles 6 nm to 10 nm in diameter can be produced. This is one example, but other surfactants can be used to cover a range of micelles 3 nm to 10 nm in diameter.

The gels obtained after the evaporation of the solvents are calcinated in air. Eliminating the surfactant during the thermal treatment makes it possible to generate a cohesive matrix with a homogeneous and structure porosity.

FIG. 4 illustrates the principle of self-assembly after the dip-coating of a substrate in the sol, said self-assembly being caused by evaporation leading to the formation of a sol-gel, leading after calcination to an ultra-thin perovskite-phase medium with a controlled microstructure.

0.9 g of Pluronic™F127 is dissolved in a mixture formed of 23 cm³ of absolute ethanol and 4.5 cm³ of an ammonia solution (28% ammonia by mass). The mixture is then heated under reflux for 1 hour.

20 cm³ of the aqueous solution containing lanthanum, strontium, iron, and gallium nitrates, all precursors of perovskite, are mixed in the stoichiometric proportions needed for the formation of a perovskite of the structure La_{0.8} Sr_{0.2} Fe_{0.7}Ga_{0.3} O_{3-δ} in water treated by reverse osmosis (20 mL). This solution is then added drop by drop to the surfactant solution. The molar ratios used are recorded in table 1 below:

TABLE 1

| | |
|---|---|
| n_{H2O}/nₙᵢₜᵣₐₜₑ | 111 |
| n_{EtOH}/nₙᵢₜᵣₐₜₑ | 38 |
| n_{F127}/nₙᵢₜᵣₐₜₑ | 6.7 × 10⁻³ |
| n_{F127}/n_{H2O} | 6.0 × 10⁻⁶ |

The combined solution is heated under reflux for 1 hour, then cooled to ambient temperature. The expected sol is obtained, and it remains stable over time.

A sol is synthesized using the procedure described in the following experiment section. This sol was produced to obtain the stoichiometry La_{0.8}Sr_{0.2}Fe_{0.7}Ga_{0.3}O_{3-δ}. The stoichiometry was verified by Inductively Coupled Plasma Atomic Emission spectrometry analysis (see Table 2 below) La_{0.8}Sr_{0.2}Fe_{0.7}Ga_{0.3}O_{3-δ}

TABLE 2

| | measured Ppm | |
|---|---|---|
| Elements | (mg/cm³) | measured n |
| La | 125.60 | 0.81 |
| Sr | 19.63 | 0.20 |
| Fe | 43.27 | 0.70 |
| Ga | 21.57 | 0.28 |

After the sol is left to age in a ventilated oven for 48 hours, it is subjected to the dip-coating of a membrane in dense perovskite.

The substrates used in the context of our study are membranes in perovskite sintered at 1350° C. for 10 hours in air (density relative to the membranes ≧97%, measures taken using the buoyancy method. These membranes have the same La, Sr, Fe, and Ga stoichiometry as the sol previously produced.

The membrane has the stoichiometry La_{0.8}Sr_{0.2}Fe_{0.7}Ga_{0.3}O_{3-δ}. The sample is then dried in the open air for 6 hours in order to undergo a thermal treatment in air to eliminate the nitrates and surfactant.

The membrane coated with a thin film was calcinated in air at 1000° C. for 1 hour, with the temperature rising by 1° C./min.

FIG. 6 is a diffractogram of the sol-gel powder calcinated at 1000° C. It shows the full perovskite crystallization (structure ABO₃)

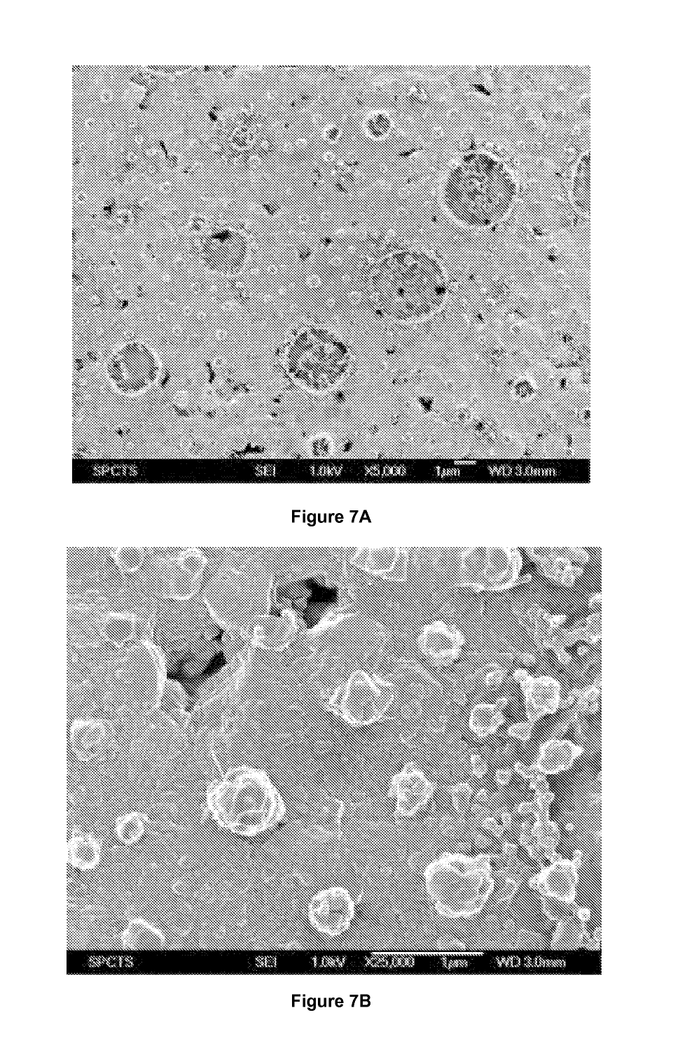

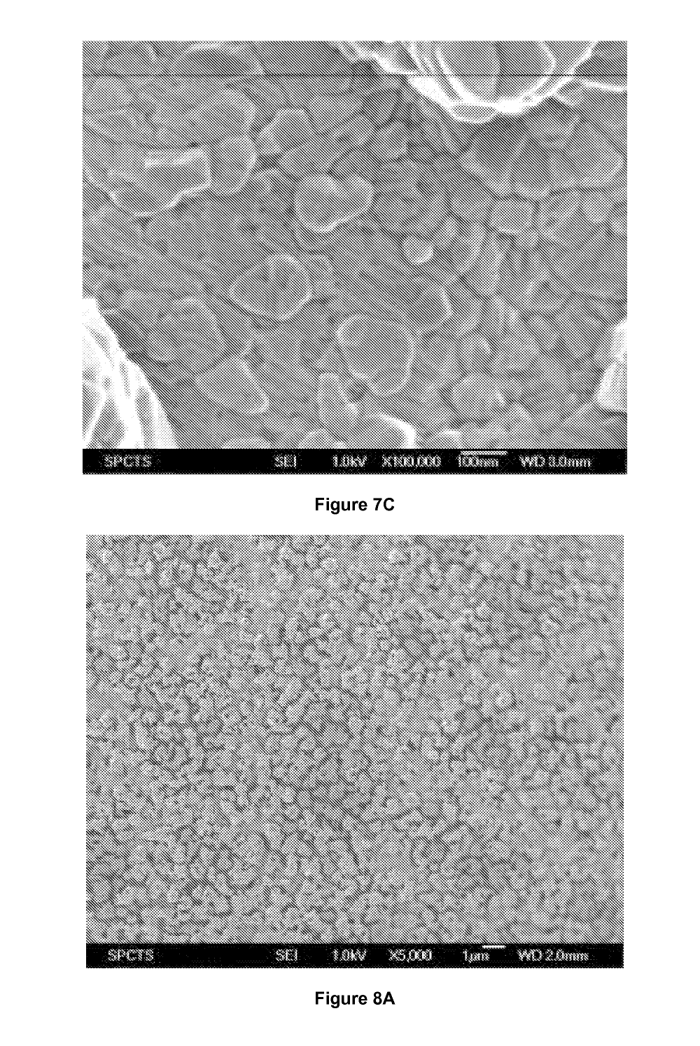

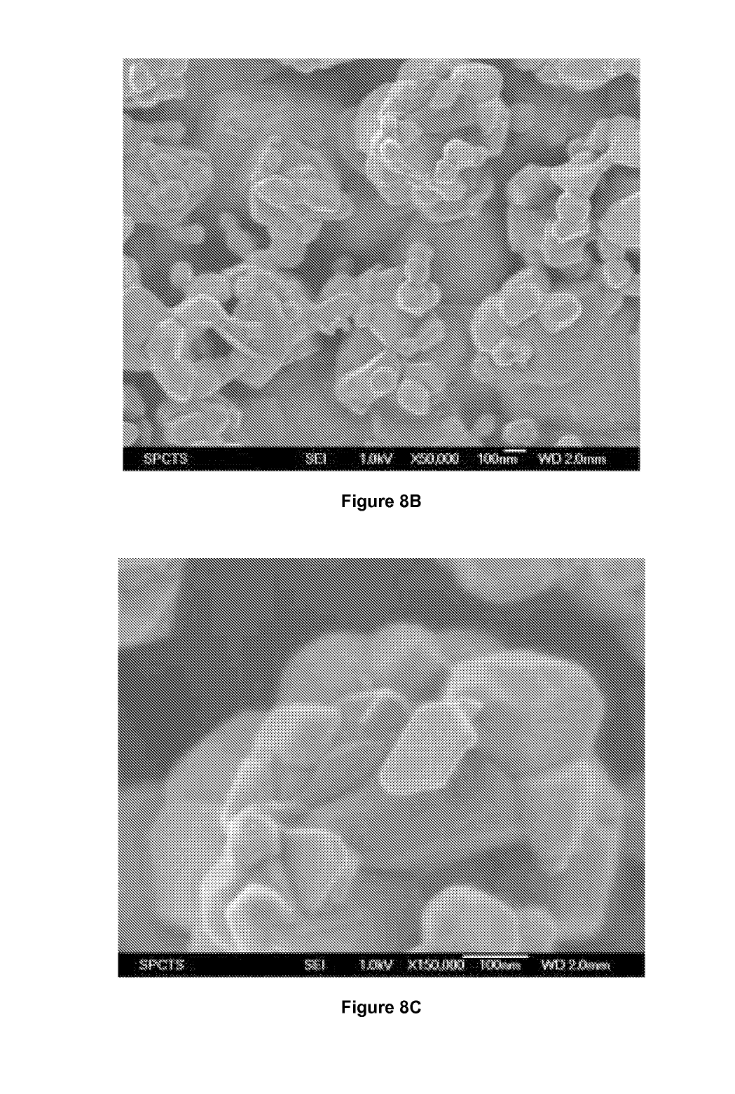

The SEM/FEG microscope images (FIGS. 7 and 8) reveal the formation of an ultrathin deposit on the surfaces of the membrane. The deposit, however, is different depending on the surface exposed to reducing gas (FIG. 7) or oxidizing gas (FIG. 8) after aging.

On the contact surface with the reducing atmosphere (illustrated by the SEM/FEG microscope images of FIGS. 7A to 7C), the drying and calcination of the sol deposit result in the surface of the membrane being coated by an ultrathin deposit composed of particles whose size is on the order of 50-100 nm. The density of grain boundaries on the surface of the membrane is very strongly increased. Clumps of grains in the form of pegs on average 200-500 nm in diameter heavily increase the gas exchange surface.

On the oxidizing surface (illustrated by the SEM/FEG microscope images of FIGS. 8A to 8C), the crystallization of the perovskite phase results in an ultrathin, highly porous deposit with crystallized particles having facets in contact with one another. The size of these particles is on the order of hundreds of nanometers, and their particle size distribution is more compact.

The oxygen semi-permeation performance of the membranes that underwent dip-coating in sol was measured.

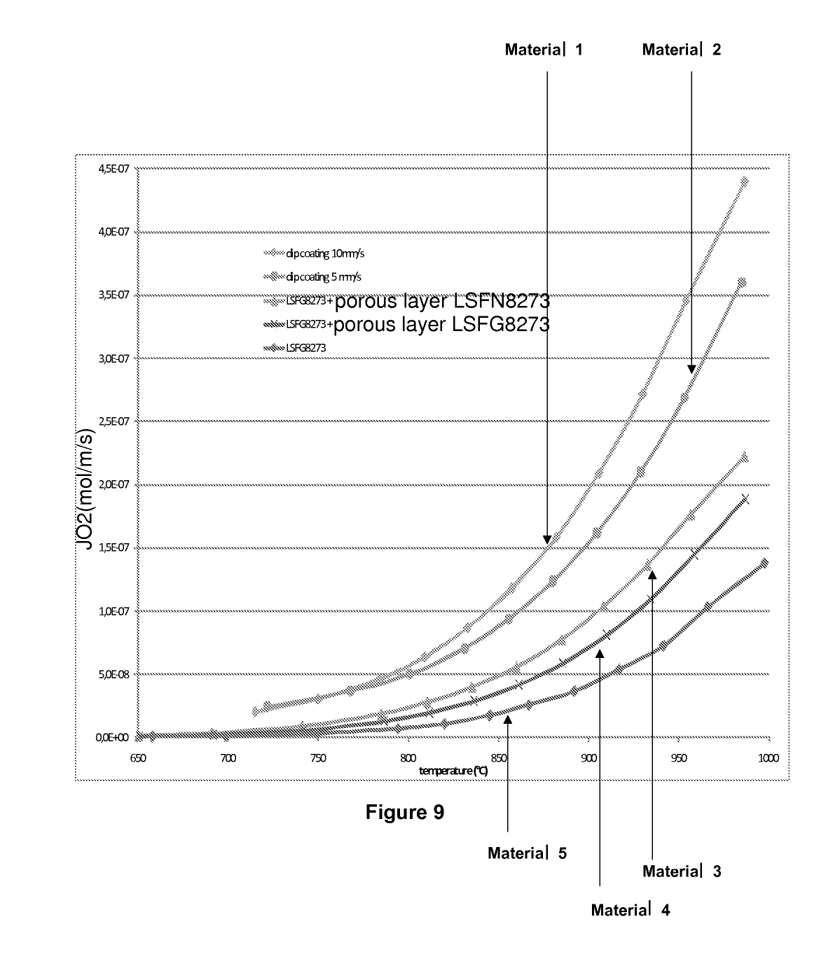

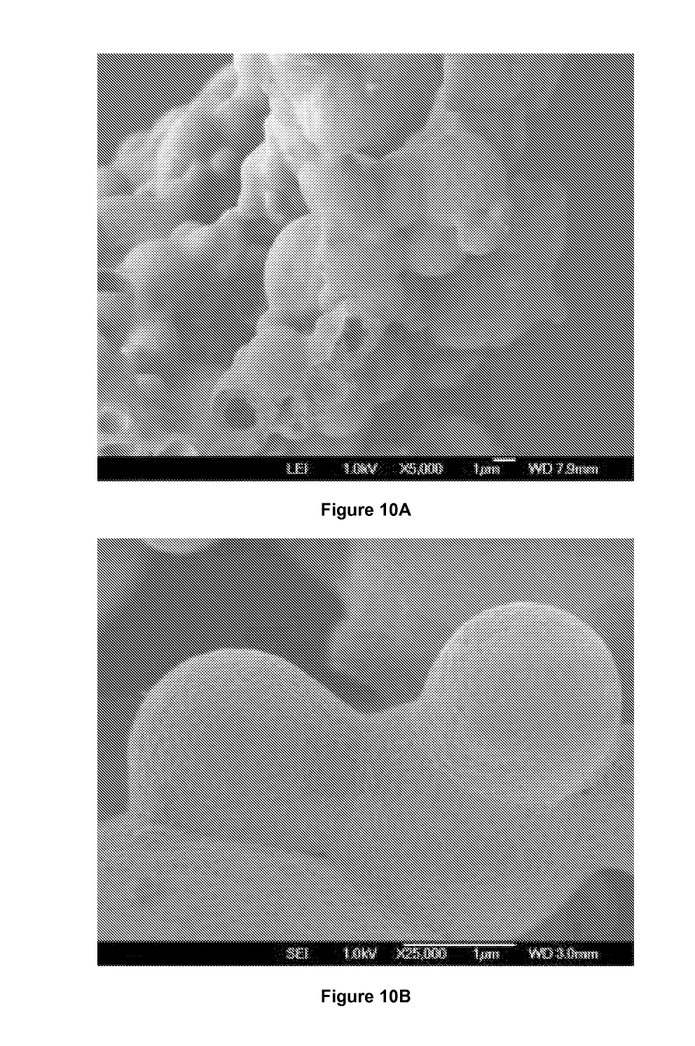

FIG. 9 shows the oxygen semi-permeation curves in an air/argon gradient as a function of temperature [J0₂ (in moles/m/s)=f(t° C.)] for the following five materials:

Material 1: La_{0.8}Sr_{0.2}Fe_{0.7}Ga_{0.3}O_{3-δ} (known as LSFG8273) coated with a porous coat of LSFG8273) by the method of the invention (dipping speed=10 mm/s)

Material 2: LSFG8273 coated with a porous coat of LSFG8273 by the method of the invention (dipping speed=5 mm/s)

Material 3: LSFG8273 coated by screen-printing a porous coat of LSFN8273

Material 4: LSFG8273 coated by screen-printing a porous coat of LSFG8273

Material 5: LSFG8273 alone.

Depositing a perovskite sol onto the surface of a membrane far surpasses the best performance previously obtained by depositing a screen-printed coat. The dipping speed influences the thickness of the deposited coat. A faster speed (10 mm/s) increases the thickness of the deposited coat and increases the exchange surface, as well as the density of grain boundaries on the surface. Performance is further improved. The following table shows the results obtained at 900° C.

| Membranes | JO₂ (mol · m⁻¹ · s⁻¹) |
|---|---|
| (Material 5) | 4.14 10⁻⁸ |
| (Material 4) | 7.11 10⁻⁸ |
| (Material 3) | 9.35 10⁻⁸ |
| (Material 2) | 15.3 10⁻⁸ |
| (Material 1) | 19.5 10⁻⁸ |

The primary benefit of the deposition of perovskite sol prepared by the inventive method is that it develops a large specific surface area and a high density of grain boundaries. Furthermore, this deposition is stable at an oxygen partial pressure gradient, a necessary condition for the use of a CMR for the steam reforming of methane, as well as to produce oxygen by air separation through said ceramic membrane.

The second advantage comes from the thickness of the deposit and the deposition method. This is because the deposit is 100 times thinner than with screen-printing (saving material) and because of the dipping, any dense membrane substrate geometry can be used (tubes, flat plates).

The spraying technique makes it possible to turn a sol into a solid dry form (a powder) through the use of a hot intermediary.

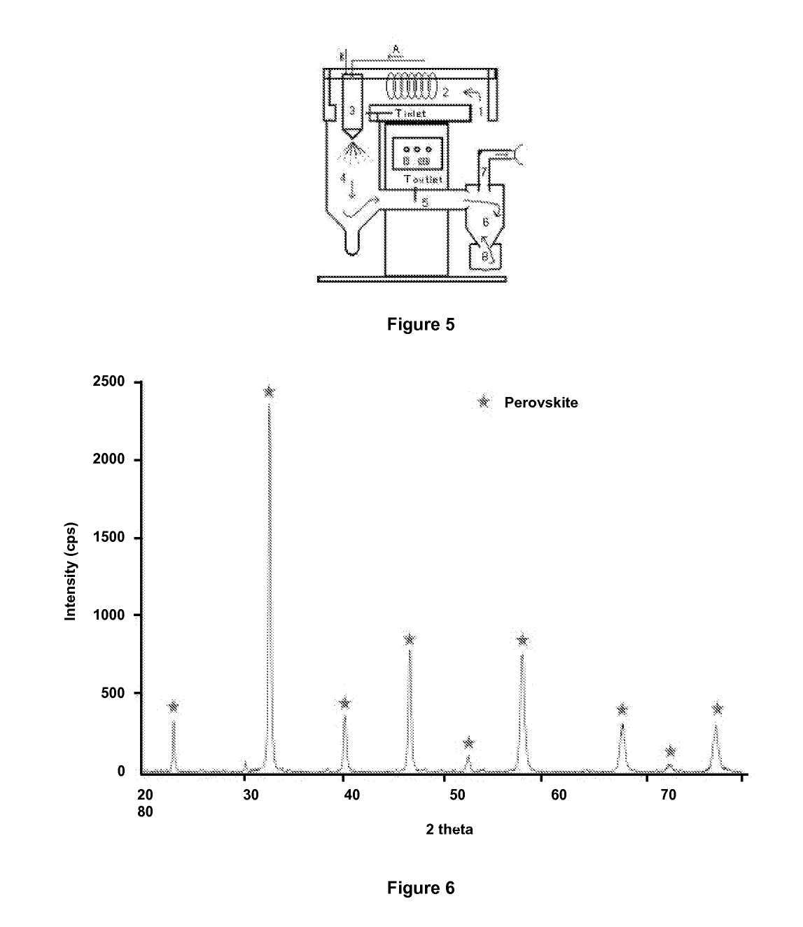

The apparatus used in our research is a commercial model known as the “190 Mini Spray Dryer” from the brand Buchi, illustrated by FIG. 5.

The method relies on spraying the sol (3) in fine drops, in a vertical cylindrical chamber (4) in contact with a hot air flow (2) in order to evaporate the solvent in a controlled manner. The resulting powder is driven by the flow of heat (5) to a cyclone (6) that will separate the air (7) from the powder (8).

The powder retrieved as a result of the spraying is calcinated under the same conditions as the substrates prepared by dip-coating.

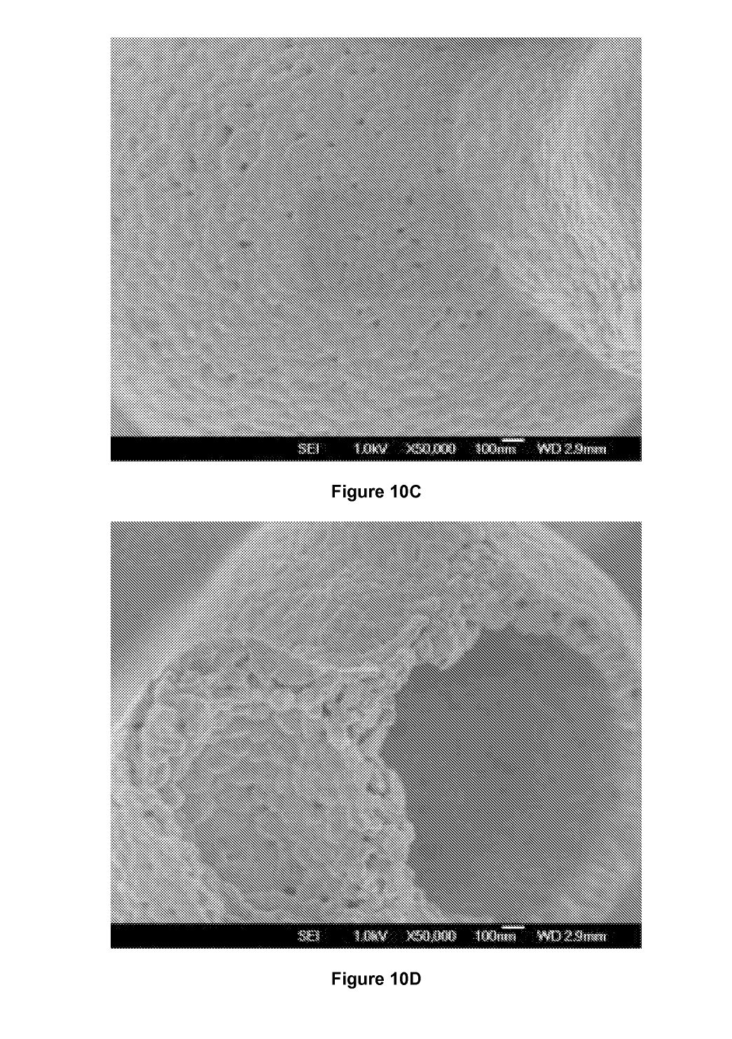

The spraying of the sol, followed by a calcination of the powder at 900° C., produces spherical granules whose diameter is less than 5 μm (FIG. 10). The microstructure of this powder is the same as that obtained on the deposit, namely an ultrathin, porous microstructure with a crystallite size on the order of 10-100 nm.

Additionally, the spherical granules are hollow and the barriers of the granules themselves have high porosity. The use of this powder to produce porous coats would make it possible to obtain a two-level porosity having a matrix with a high density of grain boundaries.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary a range is expressed, it is to be understood that another embodiment is from the one.

Optional or optionally means that the subsequently described event or circumstances may or may not occur. The description includes instances where the event or circumstance occurs and instances where it does not occur.

Ranges may be expressed herein as from about one particular value, and/or to about another particular value. When such particular value and/or to the other particular value, along with all combinations within said range.

All references identified herein are each hereby incorporated by reference into this application in their entireties, as well as for the specific information for which each is cited.

1-16. (canceled)

17. A method for preparing a sol-gel of at least three metal salts M₁, M₂, and M₃ suitable and intended for preparing a perovskite material corresponding to the general formula (I):
A₍₁₋ₓ₎A′ₓB_{(1-y-u)}B′_{y}B″ᵤO_{3-δ}, (I),
a formula (I) wherein:
x, y, u and δ are such that the electrical neutrality of the crystal lattice is preserved,
0≦x≦0.9,
0≦u≦0.5,
(y+u)≦0.5,
0≦y≦0.5 and 0≦δ
and a formula (I) wherein:
A represents an atom chosen from among scandium, yttrium, or from the lanthanide, actinide, or alkaline earth metal families;
A′, which is different from A, represents an atom chosen from among scandium, yttrium, aluminum, gallium, indium, thallium, or from the lanthanide, actinide, or alkaline earth metal families;
B represents an atom chosen from among the transitional metals;
B′, which is different from B, represents an atom chosen from among the transitional metals, the metals in the alkaline earth metal family, aluminum, indium, gallium, germanium, antimony, bismuth, tin, or lead;
B″, which is different from B and from B′, represents an atom chosen from among the transitional metals, the metals in the alkaline earth metal family, aluminum, indium, gallium, germanium, antimony, bismuth, tin, lead, or zirconium;
said method comprising the following steps:
a step a) of preparing an aqueous solution of water-soluble salts of said elements A, A′, B, and B′, in stoichiometric proportions needed to obtain the material as defined above;
a step b) of preparing a hydro-alcoholic solution of at least one non-ionic surfactant in an alcohol chosen from among methanol, ethanol, propanol, isopropanol, or butanol, mixed with an aqueous solution of ammonia in a proportion sufficient to ensure the complete dissolution of said non-ionic surfactant in said hydroalcoholic solution, the concentration of said non-ionic surfactant in said hydro-alcoholic solution being less than the critical micelle concentration;
a step c) of mixing said aqueous solution prepared in step a), with said alcoholic dispersion prepared in step b) to form a sol;
a step d) of drying said sol obtained in step c), by evaporating the solvent, to obtain a sol-gel.

18. The method as defined in claim 17, wherein the non-ionic surfactant implemented in step b) is a block copolymer (EO)₉₉-(PO)₇₀-(EO)₉₉.

19. The method as defined in claim 17, for which in the formula (I), A represents a lanthanum atom, a calcium atom, or a barium atom.

20. The method as defined in claim 17, for which in the formula (I), A′ represents a strontium atom.

21. The method as defined in claim 17, for which in the formula (I), B represents an iron atom.

22. The method as defined in claim 17, for which in the formula (I), B′ represents a gallium atom, a titanium atom, or a cobalt atom.

23. The method as defined in claim 17, for which in the formula (I), B″ represents a zirconium atom.

24. The method as defined in claim 17, for which in the formula (I), u is equal to 0.

25. The method as defined in claim 24, for which the perovskite material of formula (I) is chosen from among the following compounds:
La₍₁₋ₓ₎ Srₓ Fe(_{1-y)} Co_{y} O_{3-δ}, La₍₁₋ₓ₎ Srₓ Fe_{(1-y)} Ga_{y} O₃₋₆₇ , La₍₁₋ₓ₎ Srₓ Fe_{(1-y)} Ti_{y} O_{3-δ},
Ba₍₁₋ₓ₎ Srₓ Fe_{(1-y)} Co_{y} O_{3-δ}, Ca Fe_{(1-y)} Ti_{y} O_{3-δ} or La₍₁₋ₓ₎SrₓFeO_{3-δ}

26. The method as defined in claim 25, for which the perovskite material of formula (I) is selected from the group consisting of the following compounds:
La_{0.6} Sr_{0.4} Fe_{0.8} Ga_{0.1} O_{3-δ},
La_{0.5} Sr_{0.5} Fe_{0.9} Ti_{0.1} O_{3-δ},
La_{0.6} Sr_{0.4} Fe_{0.9} Ti_{0.1} O_{3-δ},
La_{0.5} Sr_{0.5} Fe_{0.9} Ti_{0.1} O_{3-δ},
La_{0.5} Sr_{0.5} Fe_{0.9} Ti_{0.1} O_{3-δ},
La_{0.6} Sr_{0.4} Fe_{0.9} Ga_{0.1} O_{3-δ}, and
La_{0.8} Sr_{0.2} Fe_{0.7}Ga_{0.3} O_{3-δ}.

27. A method for preparing a substrate coated on at least one of its surfaces with a sol-gel film of a perovskite material, the method comprising the steps of:
a step e) of dipping a substrate formed of a sintered perovskite material whose density is above 90%, in the sol derived from step c) of the method as defined in any one of the claims 1 to 10, to obtain a dipped substrate;
a step f) of drawing said dipped substrate derived from step e) at constant speed, in order to obtain a substrate coated with a film of said sol; and
a step g) of drying said substrate coated with a film of said sol obtained in step f), by evaporating the solvent, to obtain said substrate coated with a sol-gel.

28. The method as defined in claim 27, wherein said sintered perovskite material whose density is above 90%, is a ceramic composition (CC) comprising, out of 100% of its volume, at least 75% by volume and up to 100% by volume of a mixed electronic conductive compound and of oxygen O²⁻ (C₁) anions chosen from among the doped ceramic oxides of formula (II):
C₍₁₋ₓ₋ᵤ₎C′ₓD_{(1-y-u)}D′_{y}D″ᵤO_{3-δ}, (II),
a formula (II) wherein:
x, y, u and δ are such that the electrical neutrality of the crystal lattice is preserved,
0≦x≦0.9,
0≦u≦0.5,
(y+u)≦0.5,
0≦y≦0.5 and 0<δ
and a formula (I) wherein:
C represents an atom chosen from among scandium, yttrium, or from the lanthanide, actinide, or alkaline earth metal families;
C′, which is different from C, represents an atom chosen from among scandium, yttrium, aluminum, gallium, indium, thallium, or from the lanthanide, actinide, or alkaline earth metal families;
D represents an atom chosen from among the transitional metals;
D′, which is different from D, represents an atom chosen from among the transitional metals, the metals in the alkaline earth metal family, aluminum, indium, gallium, germanium, antimony, bismuth, tin, or lead;
D″, which is different from D and from D′, represents an atom chosen from among the transitional metals, the metals in the alkaline earth metal family, aluminum, indium, gallium, germanium, antimony, bismuth, tin, lead, or zirconium;
said ceramic composition (CC) having undergone a step of sintering before it is implemented in step e).

29. The method as defined in claim 28, wherein said ceramic composition (CC) comprises between 90% by volume to 100% by volume of compound (C₁) and between 0% to 10% by volume of compound (C₂).

30. The method as defined in claim 28, further comprising up to 25% by volume of a compound (C₂), different from the compound (C₁) chosen from among magnesium oxide, calcium oxide, aluminum oxide, zirconium oxide, titanium oxide, mixed oxides of strontium and aluminum, or of barium and titanium, or of calcium and titanium

31. The method as defined in claim 28, wherein formulas (I) and (II) are identical.

32. A method for preparing a ceramic membrane (CM) wherein said substrate coated with a sol-gel obtained by the method as defined in claim 27, undergoes a step h) of calcination in air.

33. A method for preparing an ultrathin or nanostructured powder having sizes of between 10 nm and 100 nm of a perovskite material corresponding to the general formula (I), wherein the sol from step c) of the method as defined in claim 17, undergoes a step i) of spraying in order to form a sol-gel powder; said sol-gel powder then being subjected to step h) of calcination in air, in order to form said ultrathin or nanostructured powder.
